(19) United States
(12) Patent Application Publication
(10) Pub. No.: US 2024/0391188 A1
(43) Pub. Date: Nov. 28, 2024

(54) METHOD FOR MANUFACTURING SPARS OR RIBS FOR AIRCRAFTS

(71) Applicant: Airbus Operations S.L., Getafe (ES)

(72) Inventors: Yolanda MIGUEZ CHARINES, Getafe (ES); Antonio José FUENTES ESPEJO, Getafe (ES); Pablo VAZQUEZ SANCHEZ, Getafe (ES); Angel FERNANDEZ VILCHES, Getafe (ES)

(21) Appl. No.: 18/670,194

(22) Filed: May 21, 2024

(30) Foreign Application Priority Data
May 22, 2023 (EP) 23382473-9

(51) Int. Cl. B29C 70/54; B29L 31/30

(52) U.S. Cl. CPC B29C 70/543; B29C 70/544; B29L 2031/3085

(57) ABSTRACT

A method for manufacturing spars or ribs for aircraft by placing at least one stiffener on one side of a spar web; placing a vacuum bag on the at least one stiffener and the spar web; and co-curing the at least one stiffener and the spar web. The two may be co-cured to a level of curing between 60 to 80%.

### CROSS-REFERENCES TO RELATED APPLICATIONS

This application claims the benefit of European Patent Application Number 23 382 473.9 filed on May 22, 2023, the entire disclosure of which is incorporated herein by way of reference.

### FIELD OF THE INVENTION

The present invention relates to a method for manufacturing spars or ribs for aircrafts, in particular, for manufacturing spars or ribs formed from a composite material, constituted by a spar web and stiffeners.

### BACKGROUND OF THE INVENTION

The spars or ribs for aircrafts currently know typically consist of a flat or C- or L- or Z-shaped part to which T- or L-shaped stiffeners are joined, e.g., bonded, or co-cured or co-bonded.

Both co-bonding and secondary bonding involve the need for a peel ply prepreg and adhesive to ensure the quality of the bond between the stiffeners and spar.

The challenge of manufacturing spars or ribs with stiffeners occurs because it is difficult to do so if the spars or ribs have stiffeners on both sides of the spar web. In such cases, what is usually done is to cure the stiffeners on one side and place a peel ply on the other side, so that the stiffeners on the other side are co-bonded or bonded in a subsequent cycle.

This subsequent cycle makes the method and the tooling more complex.

### SUMMARY OF THE INVENTION

Therefore, an objective of the present invention is to provide a manufacturing method that permits the elimination of peel ply and/or adhesive and/or curing cycles.

With the manufacturing method of the invention, the aforementioned drawbacks are resolved, presenting other advantages that will be described below.

The manufacturing method according to the present invention is defined in claim 1. Additional optional features are included in the dependent claims.

In particular, the method for manufacturing a spar for aircrafts comprises the following steps:
placing at least one stiffener on one side of a spar web;
placing a vacuum bag on the at least one stiffener and the spar web; and
co-curing the at least one stiffener and the spar web.

Preferably, the at least one stiffener and the spar web are co-cured until the spar web and the stiffener material is cured at a percentage between 60 and 80%.

The co-curing of the at least one stiffener and the spar web is made placing the curing tools outside the vacuum bag, so that no adhesive ply between the stiffener feet and the spar web is needed.

Preferably, the, or each, stiffener comprises a foot and a web. The stiffener should be formed bending the stiffener foot or formed bending the stiffener web, but in that case the foot should be cut with a smooth angle respect to the spar web.

If wished, at least one additional stiffener can be placed on and joined to another side of the spar web, and in this case, preferably, the at least one additional stiffener is joined to another side of the spar web by co-bonding. As the spar web is cured between 60% and 80%, no peel ply on the spar web is need for this co-bonding. If the additional stiffener is co-bonded using curing tools outside the vacuum bag, the adhesive ply between the spar web and the stiffener feet can be avoided.

Preferably, the at least one stiffener has a T or L shape, and the spar web is flat or has a C-shape or a L-shape or a Z-shape.

The manufacturing method according to the present invention has the following advantages over the previous state of the art:
Elimination of the peel ply and/or adhesive.
Reduction of the curing time.
Simplicity of the tooling to be used in the manufacturing method.

### BRIEF DESCRIPTION OF THE DRAWINGS

For a better understanding of what has been stated, some drawings are attached in which, schematically and only as a non-limiting example, a practical case of embodiment is represented.

FIG. 1 is a diagrammatical cross-section view of a spar for aircrafts during a co-curing step of the manufacturing method of the present invention;

FIG. 2 is a diagrammatical cross-section view of a spar manufactured by the method of the present invention, according to a first embodiment; and

FIG. 3 is a diagrammatical cross-section view of a spar manufactured by the method of the present invention, according to a second embodiment.

### DETAILED DESCRIPTION OF A PREFERRED EMBODIMENTS

The manufacturing method according to the present invention is for manufacturing spars or ribs for aircrafts, in particular for manufacturing composite spars 1 made from carbon fiber reinforcement plastic (CFRP), comprising a flat or Z-, L- or C-shaped spar web 2 and one or more T- or L-shaped stiffeners 3, so that the stiffener(s) 3 comprise(s) a foot and a stiffener web.

Firstly, at least one stiffener 3 is placed on one side of the spar web 2. Before this placement the foot of the stiffener(s) 3 can be shaped, i.e., providing a book effect on an edge of the stiffener foot so that it does not dig into the spar web 2, or the edge of the stiffener(s) 3 can be cut corresponding to the foot at an angle of less than 90° with respect to the spar web.

Then, a vacuum bag 4 is placed on the at least one stiffener 3 and the spar web 2, for co-curing the at least one stiffener 3 and the spar web 2. Preferably, the at least one stiffener 3 and the spar web 2 are co-cured until the stiffener and spar material is cured at a percentage between 60 and 80%, and not until 100%, as usual in the prior art.

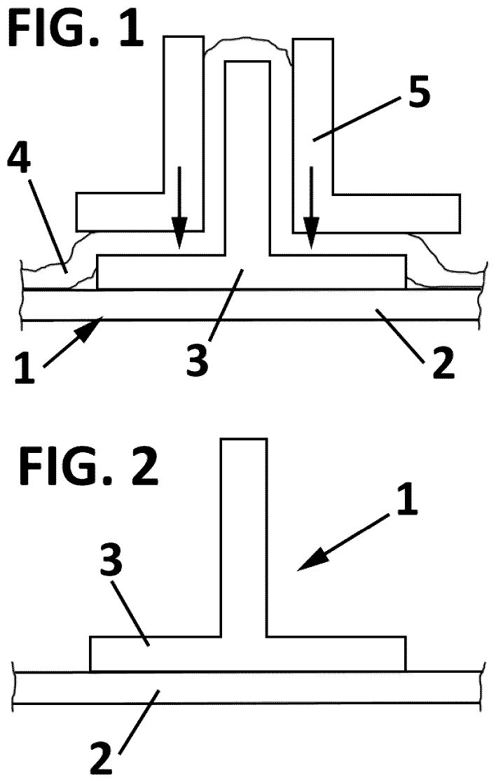

As the co-curing is done with curing tools 5 outside the vacuum bag 4, as shown in FIG. 1, there is no need of neither adhesives nor peeling elements.

As the stiffener(s) 3 and the spar web 2 are co-cured with the curing tools 5 outside the vacuum bag 4, it is possible to eliminate the adhesive, as the vacuum bag 4 itself forces the foot of the stiffener 3 to adhere to the spar web 2 geometry, guaranteeing the quality of the bond line without adhesive.

In this case, considering the usually small dimensions of the vertical stiffeners of the spars, it is even possible for the curing tools 5 to be made of 3D printing material, as the expansion difference between the composite and the 3D printing material has less influence on small dimensions and the surface quality of the curing tools 5 is less important when the curing tools 5 are placed outside the vacuum bag 4.

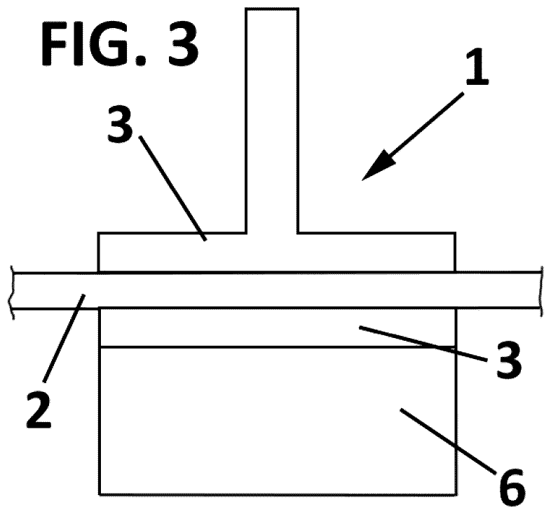

Two alternative embodiments of a spar 1 for aircrafts manufactured by the method according to the present invention are shown in FIGS. 2 and 3.

In FIG. 2, only one stiffener 3 is shown, but the spar 1 can comprise more than one stiffener 3. Furthermore, in this embodiment, the at least one stiffener 3 is placed on one side of the spar 1.

In FIG. 3, the spar 1 comprises more than one stiffener 3, placed and joined on both sides of the spar 1.

Preferably, after carrying out the steps of the method as described previously, at least one additional stiffener 6 is joined to the other side of the spar 1 by co-bonding.

Despite the fact that reference has been made to a specific embodiment of the invention, it is clear to a person skilled in the art that the described manufacturing method is susceptible to numerous variations and modifications, and that all the mentioned details can be substituted by others technically equivalent ones, without departing from the scope of protection defined by the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing spars or ribs for aircrafts, the method comprising:
placing at least one stiffener on one side of a spar web;
placing a vacuum bag on the at least one stiffener and the spar web; and
co-curing the at least one stiffener and the spar web.

2. The method according to claim 1, wherein the at least one stiffener and the spar web are co-cured until the at least one stiffener and the spar web material are cured at a percentage between 60 and 80%.

3. The method according to claim 1, wherein the co-curing of the at least one stiffener and the spar web is made placing curing tools outside the vacuum bag.

4. The method according to claim 1, wherein each stiffener comprises a foot and the foot is cut with respect to the spar web.

5. The method according to claim 4, wherein the foot is cut forming an acute angle with respect to the spar web.

6. The method according to claim 1, wherein at least one additional stiffener is placed on and joined to another side of the spar web.

7. The method according to claim 6, wherein the at least one additional stiffener is joined to another side of the spar web by co-bonding.

8. The method according to claim 1, wherein the at least one stiffener has a T or L shape.

9. The method according to claim 1, wherein the spar web is flat or has a C-shape or a L-shape or a Z-shape.
